(19) United States
(12) Patent Application Publication
(10) Pub. No.: US 2015/0007446 A1
(43) Pub. Date: Jan. 8, 2015

(54) ROTARY FRICTION DRYER AND METHOD OF USE

(71) Applicant: Enginuity Worldwide, LLC, Columbia, MO (US)

(72) Inventor: Heimann L. Robert, Columbia, MO (US)

(73) Assignee: Enginuity Worldwide, LLC, Columbia, MO (US)

(21) Appl. No.: 14/215,668

(22) Filed: Mar. 17, 2014

Related U.S. Application Data
(60) Provisional application No. 61/792,972, filed on Mar. 15, 2013.

(51) Int. Cl. F26B 3/00; F26B 25/14

(52) U.S. Cl. CPC F26B 3/00; F26B 25/14
USPC 34/386; 34/108

(57) ABSTRACT

A rotary friction dryer or gasifier and a method of using the same is provided. The rotary friction dryer generally comprises an entrance stage, an exit stage, a decompression zone located such that it separates the entrance and exit stages, a multi-stage compression screw, a mixing means coupled to the screw, at least one exhaust vent located in the decompression zone, and at least one discharge outlet located in the exit stage. The entrance stage includes an intake throat and the temperature of each stage (entrance and exit) is controllable.

### CROSS REFERENCE TO RELATED APPLICATIONS

This application is claims the benefit of the filing date under 35 U.S.C. §119(e) of U.S. Provisional Application No. 61/792,972 filed Mar. 15, 2013, the entire contents of which is hereby incorporated herein by reference.

### FIELD

The present disclosure relates to renewable energy sources, and in particular, resources that do not depend on fossil fuels and that reduce emissions of “greenhouse gas” carbon dioxide into the atmosphere. More specifically, the present disclosure relates to manufacturing processes for creating combustible biomass, including but not limited to dry or roasted biomass; biochar; wood vinegar (e.g., pyroligineous acid), carbon, or bio-product materials.

### BACKGROUND

The statements in this section merely provide background information related to the present disclosure and may not constitute prior art. Rotary screw methods for drying and/or gasifying biomass materials utilize simple frictional forces to continuously compress the biomass through the entire screw length, and apply additional compression through a narrow opening, known as the compression zone. The heat generated by these frictional forces is adequate to dry the biomass or the process can be adjusted to gasify in a continuous manner. As currently designed and operated, these rotary screw dryers provide a basis for an explosive, violent, incomplete and unmanageable, but low cost method of drying, partial pyrolysis, pyrolysis, and gasification.

### SUMMARY

In one form of the present invention, a rotary friction dryer or gasifier is provided that comprises an entrance stage, an exit stage, a decompression zone located such that it separates the entrance and exit stages, a multi-stage compression screw, a mixing means coupled to the screw, at least one exhaust vent located in the decompression zone, and at least one discharge outlet located in the exit stage. The entrance stage includes an intake throat and the temperature of each stage (entrance and exit) is controllable. The temperature of the decompression zone may also be controllable. A portion of the multistage compression screw is in the entrance stage, the decompression zone, and the exit stage. Optionally, the at least one exhaust vent located in the decompression zone may be coupled to a vacuum system.

According to another aspect of the present disclosure, the rotary friction dryer further comprises an aftercooling device that is coupled to the discharge outlet in the exit stage. The aftercooling device may include both an upward discharge outlet and a downward facing discharge outlet.

According to another aspect of the present disclosure, the mixing means comprises more than one small pin located in the threads of the screw. The small pin may have a length that is equal to about 2% to about 98% of the depth of the threads. The small pins may be located on the portion of the screw that is within the decompression zone.

In another form of the present invention, a method of separating a mixture of water, solid materials, and chemicals is provided that comprises: providing a rotary friction dryer or gasifier as described herein; feeding a mixture of water, solids, and chemicals into the entrance stage to form a biomass; causing the biomass to be mixed and heated as it progresses through the entrance stage into the decompression zone, thereby forming a processed material; allowing water vapor to exit the rotary friction dryer as steam through the exhaust located in the decompression zone; causing the processed material to be further mixed and heated as it progresses from the decompression zone into the exit stage; allowing the chemicals and solid materials to exit the rotary friction dryer through the discharge outlet located in the exit stage; and collecting at least one of the chemicals or solid materials. Optionally, the method may further comprise applying a vacuum to assist removal of water vapor through the exhaust located in the decompression zone. The method may also further comprise placing a commutation mill directly over the intake throat of the rotary screw friction dryer. The method may also further comprise controlling the feed rate over the intake throat of the rotary screw friction dryer by using a vibratory feeder.

According to another aspect of the present disclosure, the temperature in the entrance stage is maintained below the kindling temperature of the biomass. The solid materials upon being removed from the exit stage are selected as one from a dry biomass, partially torrefied biomass, roasted biomass, biochar, and carbon. The solid materials upon exiting the rotary friction dryer are placed into an auger system designed to assist in reducing the temperature of the solid material to below its kindling temperature.

The chemicals separated from the water and solid materials are selected as one or more of tars, oils, and wood vinegar. The chemicals are allowed to exit the rotary friction dryer through the upward discharge outlet in the aftercooling device and the solid materials are allowed to exit the rotary dryer through the downward discharge outlet in the aftercooling device.

According to another form of the present invention, chemicals or solid materials separated and collected according to the method described herein are stored or used in a variety of applications.

Further areas of applicability will become apparent from the description provided herein. It should be understood that the description and specific examples are intended for purpose of illustration only and are not intended to limit the scope of the present disclosure.

### BRIEF DESCRIPTION OF THE DRAWINGS

In order that the disclosure may be well understood, there will now be described various forms thereof, given by way of example, reference being made to the accompanying drawings, in which:

FIG. 1 is a schematic representation of a rotary friction dryer or gasifier assembled according to the teachings of the present disclosure; and

FIG. 2 is a flowchart representation of a process or method of separating a mixture of water, solid materials, and chemicals according to the teachings of the present disclosure;

The drawings described herein are for illustration purposes only and are not intended to limit the scope of the present disclosure in any way.

### DETAILED DESCRIPTION

The following description is merely exemplary in nature and is not intended to limit the present disclosure, application, or uses. The rotary friction dryer of the present disclosure represents an improvement upon the wood gasification apparatus described in U.S. Pat. No. 7,144,558, entitled “Wood Gasification Apparatus” issued on Dec. 6, 2006, and U.S. Pat. No. 8,667,706 entitled “Rotary Biomass Dryer”, the contents of which are incorporated herein by reference in their entirety

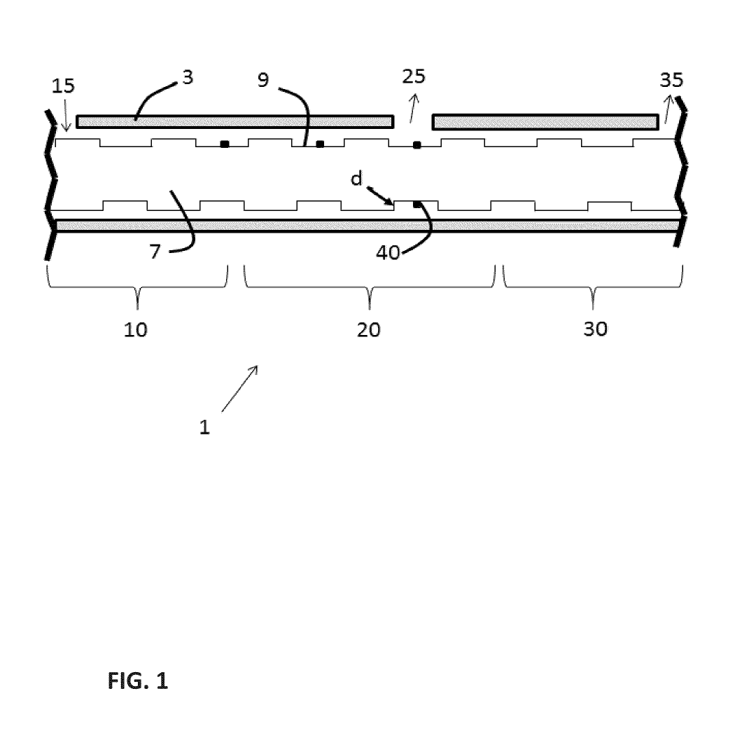

According to one aspect of the present disclosure, a rotary screw dryer designed and operated according to the teachings herein can provide a means to separate water vapor from the wood vinegar vapor by the addition of a two-stage screw separated by a decompression zone. Referring to FIG. 1, the decompression zone 20 of the rotary screw dryer 1 may be located anywhere between intake throat 15 of the feed (entrance) 10 stage and exhaust vent 35 in the exit 30 stage, and alternatively, approximately halfway between feed and exit. This decompression zone 20 will also have a position along the screw 7 for the exhaust of steam through an external port 25 in the barrel 3, as the process will expel moisture from the biomass as steam. The product temperature before entering the decompression zone 20 is preferably below the kindling temperature of the biomass. The discharge of the steam which may or may not include some mixture of low end volatile material escaping from the biomass could be through natural aspiration driven by steam expansion or assisted by vacuum.

Still referring to FIG. 1, according to another aspect of the present disclosure, a mixing means may be added to the screw 7 as the current design allows a portion of the biomass to pass through without heat treatment, and/or roasting or gasifying. The mixing means may be small pins 40 located in the root of the feed thread 9, spaced evenly or intermittently and radially or randomly about the diameter, or other mixing mean, the purpose of which is provide mixing of the biomass materials. The small pins 40 may range in size from about 2% to about 98% of the screw thread depth (d). The mixing apparatus may be located anywhere along the length of the entire screw. Alternatively, the mixing apparatus is located such that the mixing means is in a decompression zone, with or without venting of gaseous materials.

The design and use of this mixing means in a rotary friction dryer provides two benefits over the existing designs for rotary friction dryers or gasifiers. These benefits include reduction or elimination of 1) undesirable mixing of off-gases and 2) non-uniform thermal treatment of the biomass. The drying process of the present disclosure can include two outputs for vapors, the 1) first is predominately steam and the 2) second is predominately without steam, and dominated by wood vinegar vapor. Alternatively, there may also be a mixed output for all gaseous/vapor products from the rotary friction drying/gasifier process at the output, coupled with a means to separate the gaseous output into different streams that may have value.

According to another aspect of the present disclosure, solids and vapor/gasses are discharged from the rotary friction driver through the use of an aftercooling device and process. The process can be managed to produce a variety of valuable solid materials, including dry biomass, partially torrefied biomass, roasted biomass, biochar, and carbon, among others. The gaseous/vapor products from the process many include, but not be limited to, steam, water vapor, water, tars, oils, and wood vinegar.

Wood vinegar is a red-brown pyrolysis liquid (pyroligneous acid) formed by pyrolysis of biomass which contains acetic acid, methanol, acetone, wood oils, and tars. Wood vinegar is reported to increase propagation of microbes, and provide an inducing effect for plant growth. Wood vinegar is neither a fertilizer, nor an agro-chemical, yet when correctly applied to plants and/or soils, wood vinegar enhances the intake of fertilizers and reduces the damage inflected by various plant diseases. Furthermore, wood vinegar enhances rooting, balances microbiological population, reduces the tendency of soil bearing diseases which increasing the vitality of root systems which equate to better uptake of nutrients. Additionally, at certain dilutions, the wood vinegar has surfactant qualities so the uptake of water can be increased by ⅓, meaning water is more readily absorbed by plants.

In one embodiment, the rotary friction dryer according to the teachings of the present disclosure includes an aftercooling device disposed with both an upward discharge tube and a downward facing discharge tube immediately after the compression zone. The upward and downward orientation of outputs allows for the movement of the gaseous material through an upward output, and the solids through a downward output. However, any angle orientation of the two materials that splits the gas from the solid at the exit from the compression zone is possible. Alternatively, a vacuum may also be incorporated into the design in order to reverse the flow of gas downward and solids upward. One skilled in the art will understand that any means to split the physical phases (gas/vapor from solids), and any diversity of angles of discharge is anticipated without exceeding the scope of the present disclosure.

According to another aspect of the present disclosure, the treated biomass may be dried or partially pyrolyzed, or fully pyrolyzed. The dried or pyrolyzed biomass may be discharged from the flighted compression screw into a tee with one section for vapors and gasses and one partition section for solid discharge. The solids discharge section is configured with one or more cooling devices placed about the perimeter of the solid discharge means. If the discharge is a tubular, the cooling devices are placed radially around the tube. In non-radial discharge, the one or more cooling devices are placed intermittently about the perimeter. The biomass cooling devices can be water mist, steam spray, spray nozzles, dry ice flaking nozzles produced from liquid CO₂, nozzles to reintroduce wood vinegar as a cooling and/or saturation medium or CO₂ nozzles.

According to another aspect of the present disclosure, the solids output discharge pipe enters into a conventional material auger, oriented at an angle (5-75° from horizon) accumulating in a receiving bin or hopper at the origination point of the auger. The hopper or bin is sealed thereby providing a gaseous air-lock means as CO₂ is twice as heavy as oxygen. This design avoids the detail and expense of incorporating rotary air locks. Hence with an ample supply of CO₂, all oxygen is discharged out of the solid discharge point and the receiving hopper, as well as the auger.

The biomass material then is moved through the auger where additional cooling may be achieved with a jacketed, auger housing and/or a hollow-flight cooling screw both of which can be connected to a liquid chiller and pump to circulate the fluid and remove the heat. Alternatively, the auger screw may be contained in a shroud and cooling air passed through the shroud or a combination of both cooling means could be deployed to affect an aftercooler system. Mixing pins in the auger shaft may enhance cooling. The aftercooler system may also comprise other designs that will safely reduce the temperature of the biomass below its kindling temperature. The aftercooler system may optionally be situated to be separate from the rotary/gasifier, or in line, or integrated together.

The wood vinegar may be sprayed on the exiting biomass at any convenient location along the discharge route, thereby, resulting in a product that exhibits fuel properties or enhanced biochar cultivation properties, among other properties.

Alternatively, the rotary friction dryer or gasifier may include a means to inject an activating gas, vapor, or other material, including but not limited to CO₂, nitrogen, hydrogen, or steam into the compression zone. This gas or vapor will act as a chemical activator capable of producing activated carbon and/or activated biochar in situ.

According to another aspect of the present disclosure, the rotary friction dryer may also perform a secondary grinding means, i.e. particle size reduction in situ, in order to enhance and improve the processiblity of the resultant solid discharge material. When the rotary friction dryer is deployed as a gasifier, the solids discharge (possibly downward facing, among other orientations) would facilitate the removal of fully pyrolyzed biomass, also referred to as ash. The ash may be cooled with water, and/or crushed to insure no embers, and conveyed for storage and/or transport.

In order to facilitate uniform feeding of the compression screw, a commutation mill may optionally be placed directly over the intake throat of the rotary screw friction dryer or gasifier.

Another aspect of the rotary friction dryer or gasifier of the present disclosure is to provide a means of condensing valuable wood vinegar materials. In this respect, a tube or pipe may be attached to the gas vapor discharge of the rotary friction gasifier or dryer. This tube or pipe is used to carry the vapors as they cool, thereby, condensing the wood vinegar vapor. The tube or pipe can be upward or downward facing or any suitable angle in between that provides for adequate condensation. In an upward facing design, a hole provided on the underside of the tube or pipe would allow the liquid condensate to flow into a collection device. In a downward facing configuration, the liquid condensate would flow by gravity into a collection device. The collected condensate is comprised of one to many fractions/constituents with different specific gravity. The incorporation of a settling tank will allow the fractions to separate. Any pump mechanism could be deployed to relocate the condensate to a settling tank to allow for the differing fractions to separate. When desirable to expedite the separate of the condensate into different fractions, the condensate could be subjected to a centrifuge to facilitate separation of the constituents. Additionally, the tube or pipe can be deployed with cooling means to enhance the condensation of the gas/vapor materials, including wood vinegar vapors. The cooling means may be a jacketed housing around the tube/pipe or simply wrapped with flexible tubing filled with a cooling medium or material.

The compression screw deployed in the Rotary Biomass Dryer, combined with the barrel/nozzle design provides means to off gas not only unbound, but also bound waters, by producing steam. An underlying controlling facet of this design is the uniform feed rate of raw materials as overfeeding may create a plugging and catastrophic lock-up of the compression screw resulting in damage to the mechanism. Alternatively, underfeeding may create an unstable temperature profile of the mechanism and inconsistent processing of the material. Therefore a means to provide a uniform feed rate is hereby disclosed. The devices uses could be augers with variable controllers, also belts with variable federate controller, and gravity flow feeders with adjustable feed gates. One preferred method of feeding materials is a vibrator feeder, as vibrator feeder efficiency has been well demonstrated to yield consistent and controlled feed rate of all types of wet and dry materials.

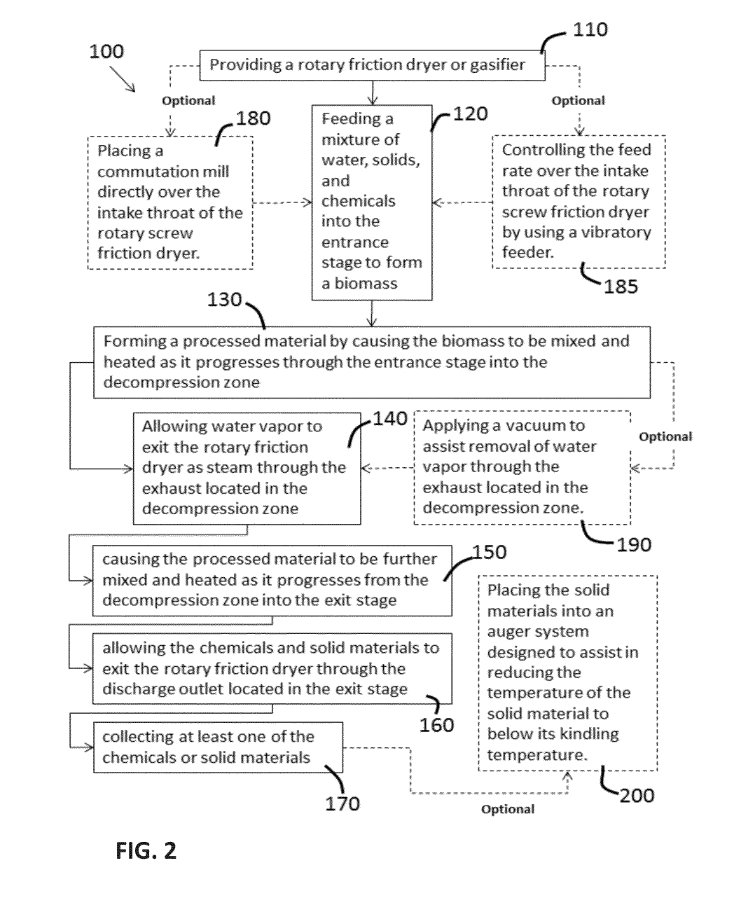

Referring now to FIG. 2, a method 100 of separating a mixture of water, solid materials, and chemicals is provided that comprises: providing 110 a rotary friction dryer or gasifier as described herein; feeding 120 a mixture of water, solids, and chemicals into the entrance stage to form a biomass; causing 130 the biomass to be mixed and heated as it progresses through the entrance stage into the decompression zone, thereby forming a processed material; allowing 140 water vapor to exit the rotary friction dryer as steam through the exhaust located in the decompression zone; causing 150 the processed material to be further mixed and heated as it progresses from the decompression zone into the exit stage; allowing 160 the chemicals and solid materials to exit the rotary friction dryer through the discharge outlet located in the exit stage; and collecting 170 at least one of the chemicals or solid materials. Optionally, the method may further comprise applying 190 a vacuum to assist removal of water vapor through the exhaust located in the decompression zone. The method may also further comprise placing 180 a commutation mill directly over the intake throat of the rotary screw friction dryer. The method may also further comprise controlling 185 the feed rate over the intake throat of the rotary screw friction dryer by using a vibratory feeder. The solid materials collected may be further placed 200 into an auger system designed to assist in reducing the temperature of the solid material to below its kindling temperature.

The present invention may be used to process a diverse group of processed material in multiple forms, moisture contents, and physical geometries. The invention can be used to process grains and other agricultural materials, including but not limited to, corn, soybean, wheat, sorghum, bagasse, oats, dry distillers grains (DDGs) among others. In some cases the inventive Rotary Biomass dryer can be used to process mixtures of grain and/or DDGs and/or biomass to achieve efficient and production processing to the desired end product.

A wood vinegar condenser captures the upward vapors in a series of cooled pipes or a liquid cooled cyclone, which is deployed to drain the wood vinegar into a container for subsequent reuse. The wood vinegar of this process may be used in many different applications, including, but not limited to use as a BTU booster for engineered fuel, as biomass fuel, as a bug spray, a plant growth enhancer, a pesticide, a wood killer, an anti-fungal material. These beneficial uses are accomplished by varying the ratios of wood vinegar to water in an aqueous solution. The wood vinegar can also be used as an additional saturate to biochar, which can be accomplished in a continuous process using this invention, or as a two-step process. The combination of biochar with wood vinegar is a product achievable by this process that would be beneficial for agricultural or horticultural uses.

### EXAMPLE 1

The solid discharge from a rotary friction dryer designed and operated according to the teachings of the present disclosure is collected and tested. The solid discharge is found to comprise 200 cc by volume of roasted corn stover, 20 cc by volume of roasted hardwood, ½% binder based on the total volume, and 8 milliliters of NaOH. The solid discharge is mixed and placed into a 2″ die at a temperature of 110° C. The die is compressed using a hydraulic press until the material refusal (35 tons)

The densified material is tested using a Quick Water Test in which the densified puck describe above is compared against a conventional material pellet not exposed to the rotary friction dryer of the present disclosure. This conventional material pellet comprises an 8 mm stover pellet (without rotary friction drying), that immediately absorbs 2 drops of water and swells to a totally soft material. The 2″ puck of the present disclosure induces immediate beading of the water drops, but slowly adsorbs the water. The 2″ puck of the present disclosure is placed into a water immersion bath and is observed to sink since its density is greater than 40 lbs/ft³.

It should be noted that the invention is not limited to the various forms described and illustrated as examples. A large variety of modifications have been described and more are part of the knowledge of the person skilled in the art. These and further modifications as well as any replacement by technical equivalents may be added to the description and figures, without leaving the scope of the protection of the disclosure and of the present patent.

What is claimed is:

1. A rotary friction dryer or gasifier comprising:
an entrance stage and an exit stage; wherein the entrance stage includes an intake throat and the temperature of each stage is controllable;
a decompression zone located such that it separates the entrance and exit stages;
a multi-stage compression screw a portion of which is in the entrance stage, decompression zone, and exit stage;
a mixing means coupled to the screw;
at least one exhaust vent is located in the decompression zone; and
at least one discharge outlet located in the exit stage.

2. The rotary friction dryer of claim 1, wherein the rotary friction dryer further comprises an aftercooling device coupled to the discharge outlet in the exit stage.

3. The rotary friction dryer of claim 1, wherein the mixing means is more than one small pin located in the threads of the screw; the small pin having a length that is equal to 2% to 98% of the depth of the threads.

4. The rotary friction dryer of claim 3, wherein the small pins are located on the portion of the screw that is within the decompression zone.

5. The rotary friction dryer of claim 1, wherein the at least one exhaust vent located in the decompression zone is coupled to a vacuum system.

6. The rotary friction dryer of claim 2, wherein the aftercooling device includes both an upward discharge outlet and a downward facing discharge outlet.

7. A method of separating a mixture of water, solid materials, and chemicals, the method comprising:
providing a rotary friction dryer or gasifier according to claim 1;
feeding a mixture of water, solids, and chemicals into the entrance stage to form a biomass;
causing the biomass to be mixed and heated as it progresses through the entrance stage into the decompression zone, thereby forming a processed material;
allowing water vapor to exit the rotary friction dryer as steam through the exhaust located in the decompression zone;
causing the processed material to be further mixed and heated as it progresses from the decompression zone into the exit stage;
allowing the chemicals and solid materials to exit the rotary friction dryer through the discharge outlet located in the exit stage; and
collecting at least one of the chemicals or solid materials.

8. The method of claim 7, wherein the temperature in the entrance stage is below the kindling temperature of the biomass.

9. The method of claim 7, wherein the method further comprises applying a vacuum to assist removal of water vapor through the exhaust located in the decompression zone.

10. The method of claim 7, wherein the solid materials upon being removed from the exit stage are selected as one from a dry biomass, partially torrefied biomass, roasted biomass, biochar, and carbon.

11. The method of claim 7, wherein the chemicals separated from the water and solid materials are selected as one or more of tars, oils, and wood vinegar.

12. The method of claims 7, wherein the rotary friction dryer further comprises an aftercooling device coupled to the discharge outlet in the exit stage.and the chemicals are allowed to exit the rotary friction dryer through an upward discharge outlet in the aftercooling device and the solid materials are allowed to exit the rotary dryer through a downward discharge outlet in the aftercooling device.

13. The method of claims 7, wherein the solid materials upon exiting the rotary friction dryer are placed into an auger system designed to assist in reducing the temperature of the solid material to below its kindling temperature.

14. The method of claim 7, wherein the method further comprises placing a commutation mill directly over the intake throat of the rotary screw friction dryer.

15. The method of claim 7, wherein the method further comprises controlling the feed rate over the intake throat of the rotary screw friction dryer by using a vibratory feeder.

16. Chemicals or solid materials separated and collected according to the method of claim 7.
